(19) United States
(12) Patent Application Publication
(10) Pub. No.: US 2010/0154917 A1
(43) Pub. Date: Jun. 24, 2010

(54) THERMALLY INSULATED PIPE FOR USE AT VERY HIGH TEMPERATURES

(75) Inventors: Maurice Batallas, Calgary (CA); Peter Singh, Caledon (CA)

Correspondence Address: LAW OFFICE OF DELIO & PETERSON, LLC., 121 WHITNEY AVENUE, 3RD FLLOR, NEW HAVEN, CT, 06510, US

(73) Assignee: SHAWCOR LTD., Toronto, ON (CA)

(21) Appl. No.: 12/376,982

(22) PCT Filed: Aug. 3, 2007
(86) PCT No.: PCT/CA07/01371

§ 371 Date: Feb. 10, 2009

(30) Foreign Application Priority Data
Aug. 10, 2006 (CA) 2555756

(51) Int. Cl. F16L 9/14; F16L 59/14

(52) U.S. Cl. 138/141; 138/149; 138/153; 138/146

(57) ABSTRACT

The present invention provides an insulated pipe comprising a pipe and a composite insulation system, said composite insulation system comprising: (a) a first insulation layer comprising a first insulation material having a thermal conductivity k-factor value of less than 0.023 W/m-K at 38° C.; and (b) at least one additional insulation layer comprising an insulation material having a thermal conductivity k-factor greater than that of the first insulation material and a maximum operating temperature limit less than that of the first insulation layer. The composite insulation system is bonded to an exterior surface of the pipe with the first insulation layer facing towards said exterior surface of the pipe. At least one of said first insulation layer or said at least one additional layer extends continuously about the exterior surface of the pipe. The present invention further provides an insulated pipe for use in an undersea pipeline and an insulated pipe for use in a subterranean pipeline.

### FIELD OF INVENTION

The present invention relates to insulated pipes comprising a thermal insulation system particularly for use at very high operating temperatures and having very low heat loss and insulation thickness in comparison with conventional high temperature insulation systems used with pipes.

### BACKGROUND

Structures used to store or transport materials at temperatures exceeding the temperature of the surroundings are often coated with materials that retard the flow of heat to the surroundings. Pipelines and other structures employed in transporting oil, natural gas, petroleum products and other products are often insulated to maintain a temperature such that the contents remain sufficiently warm to be flowable, or to prevent the precipitation of components such as wax (from crude oil) or hydrogen sulphide hydrates (from raw gas). Pipelines are also used to transport heated water for use in district heating, in which case it is important to minimize the loss of stored energy contained within the heated water and to maximize the efficiency of heat exchangers needed to extract said stored energy.

Traditionally such structures have operated at temperatures sufficiently low that they could be insulated with closed cell, water-resistant organic foams, such as polyurethane or polyisocyanurate foams. However, several important applications require the use of operating temperatures in excess of those which traditional closed-cell polymeric foams can withstand. These applications include the extraction of oil from very deep wells, the transport over long distances of bitumen, the transport of steam for injection into heavy oil wells or to extend the useful production life of older wells, and the use of steam or hot water-based district heating systems. These new high temperature applications may require insulation systems designed to operate continuously at operating temperatures exceeding 150° C., for a minimum of 20-30 years. Service temperature limitations of polymeric foams such as polyurethane (PUF) and polyisocyanurate (PIF) materials for continuous long-term use, however, are limited to approximately 150° C. There is thus a need for thermal insulation systems that can operate at temperatures exceeding 150° C. while retaining or exceeding the thermal insulation efficiency of existing closed-cell foam systems.

For these high temperature applications, it is known to use inorganic insulations that can withstand much higher temperatures. Examples of such inorganic insulation systems include foamed glass, fibre mats formed from glass or spun minerals, and preformed half shells based on calcium silicate, an example of which is sold under the trade name Thermo-12. Other examples include mineral fillers and mortars such as perlite (an expanded mineral), and calcium silicate. However, such inorganic insulation materials suffer a number of very significant drawbacks. In all cases, the thermal conductivity is much higher than that of closed cell organic foams, thus requiring very great thickness in order to achieve an acceptable level of heat retention. Furthermore, with the exception of foamed glass, all are extremely permeable to water. If such materials come into contact with water, such as from a leak in the outer jacket protecting the insulation from the elements, the inorganic insulation will become sodden and it will no longer act as a thermal insulation. Glass foam, which is primarily closed cell and therefore less inclined to absorb water, is extremely abrasive, and will destroy any anti-corrosion coating applied to protect the pipe as a consequence of the large differential expansion that high temperature pipelines undergo on startup and in service.

For these high temperature applications, it is also known to use composite insulation designs comprising a heat resistant insulator as the initial layer adjacent to the surface overlaid by a conventional thermally efficient closed-cell lower temperature rated organic insulation. The heat resistant insulation layer provides a thermal barrier effect, lowering the transmitted temperature to a level such that the exposure temperature of the overlaid organic foam materials can be maintained within the allowable limits for the organic material. This combination of materials produces an insulation system that can operate at much higher temperature than the organic foam insulation can by itself, but at a considerable sacrifice in insulation efficiency in comparison with a system using only the organic-based thermal insulation.

Composite insulation systems for high service temperatures have previously incorporated as thermal barrier layers materials such as glass wool, mineral fibre (also known as “rock wool”), preformed half shells based on calcium silicate, asbestos, or foam glass, mineral fillers and mortars such as perlite and calcium silicate, or various combinations of these materials. These were then typically overlaid with PUF, PIF or phenolic foam.

In the particular case of buried pipelines, currently used composite insulation systems for high service temperature have numerous disadvantages. Traditional thermal barriers have relatively poor insulation value, necessitating the application of a considerable thickness to lower the temperature transmitted to the foam layer. Furthermore, many of these mineral based materials such as rock wool can be very labor intensive to apply, or in the case of mortar based materials such as perlite may require complex processing such as molding and autoclave baking in order to be cured properly. Some high temperature insulation systems use insulation materials (e.g. loose perlite or vermiculite filler) that need to be contained within another pipe in order to be held in place and protected from the environment. Many insulation materials for high service temperatures have comparatively poor insulation or physical strength properties (e.g. mineral or glass wools) and will not directly support the weight of the pipe for buried pipe systems. Because of the low compressive strength of many of the high temperature insulation materials (e.g. rock wool, or aerogel stand-alone insulation), they are primarily used for above ground pipelines. For direct burial they must be encased within a pipe-in-pipe (PIP) assembly. Both of these solutions can be extremely expensive to apply and install compared to a factory applied single pipe insulated system for buried service.

For high temperature systems, it is advantageous for the barrier layer to have a thermal insulating capability at least equal to, and preferably better than that of a PUF or PIF overlayer. In the particular case of tubular structures, such as pipes, the ability to contain heat flow decreases as the diameter increases. Therefore, it is highly advantageous to minimize the additional increased diameter that results when additional layers of insulation are added. This is particularly true with smaller diameter pipes.

FIG. 1 illustrates three different situations for the relative insulating values of a multilayer insulated pipe. If the outer insulation is much more efficient than the inner insulation, even small increases in the thickness of the outer layer will require substantial increases in the thickness of the inner layer in order to maintain the interface between the two insulations at a temperature that the outer layer can withstand. If, on the other hand, the inner insulation has a lower thermal conductivity than the outer layer, only small increases in the thickness of the innermost layer of insulation will be required to reduce the interface temperature to the desired temperature. Thus, the thickness of the inner layer can be kept much lower, and the system design can be much more efficient.

### SUMMARY OF INVENTION

In one aspect, the present invention provides an insulated pipe comprising a pipe and a composite insulation system, said composite insulation system comprising: (a) a first insulation layer comprising a first insulation material having a thermal conductivity k-factor value of less than 0.023 W/m-K at 38° C.; (b) at least one additional insulation layer comprising an insulation material having a thermal conductivity k-factor greater than that of the first insulation material and a maximum operating temperature limit less than that of the first insulation layer, said composite insulation system bonded to an exterior surface of said pipe with the first insulation layer facing towards said exterior surface of said pipe; wherein at least one of said first insulation layer or said at least one additional layer extends continuously about said exterior surface of the pipe.

In another aspect, the present invention provides an insulated pipe for use in an undersea pipeline, comprising: a pipe; a composite insulation system, said composite insulation system comprising: (a) a first insulation layer comprising a first insulation material having a thermal conductivity k-factor value of less than 0.023 W/m-K at 38° C.; (b) at least one additional insulation layer comprising an insulation material having a thermal conductivity k-factor greater than that of the first insulation material and a maximum operating temperature limit less than that of the first insulation layer, said composite insulation system bonded to an exterior surface of said pipe with the first insulation layer facing towards said exterior surface of said pipe; wherein said composite insulation system is formed by application of the first insulation layer to the exterior surface of the pipe followed by application of an additional insulation layer to surround said first insulation layer, wherein at least one of said first insulation layer or said at least one additional layer extends continuously about said exterior surface of the pipe; and an outer jacket covering the composite insulation system, said outer jacket protecting the composite insulation system and pipe from water ingress and from ambient pressure.

In a further aspect, the present invention provides an insulated pipe for use in a subterranean pipeline, comprising: a pipe; a composite insulation system, said composite insulation system comprising: (a) a first insulation layer comprising a first insulation material having a thermal conductivity k-factor value of less than 0.023 W/m-K at 38° C.; (b) at least one additional insulation layer comprising an insulation material having a thermal conductivity k-factor greater than that of the first insulation material and a maximum operating temperature limit less than that of the first insulation layer, said composite insulation system bonded to an exterior surface of said pipe with the first insulation layer facing towards said exterior surface of said pipe; wherein at least one of said first insulation layer or said at least one additional layer extends continuously about said exterior surface of the pipe; at least one of a bonding layer and/or reinforcement layer for securing said composite insulation system to said pipe, said at least one bonding layer and/or reinforcement layer protecting the composite insulation system from soil stress forces; and an outer jacket covering the composite insulation system, said outer jacket protecting the composite insulation system and pipe from water ingress.

In an embodiment of the invention, the insulated pipe for use in a subsea or a subterranean pipeline comprises an outer jacket which is a watertight polymeric covering.

In a further embodiment of the invention, the watertight polymeric covering comprises an extruded polymeric material.

In a further embodiment of the invention, the watertight polymeric covering comprises an extruded polyolefin.

In a further embodiment of the invention, the watertight polymeric covering comprises an extruded polyamide.

In a further embodiment of the invention, the watertight polymeric covering comprises an extruded elastomer.

In a further embodiment of the invention, the watertight polymeric covering comprises a thermoset polymeric material.

In a further embodiment of the invention, the thermoset polymeric material comprises polyurethane, polyurea or epoxy.

In an embodiment of the invention, the insulated pipe for use in a subsea or a subterranean pipeline comprises an outer jacket which is a pipe.

In a further embodiment of the invention the pipe comprises a metal.

In an embodiment of the invention, the composite insulation system is formed by application of the first insulation layer to the exterior surface of the pipe followed by application of an additional insulation layer to surround said first insulation layer, and wherein application of one or more of the first insulation layer or additional insulation layers is performed in an continuous manner.

In an embodiment of the invention, the first insulation material has a thermal conductivity k-factor value of less than 0.020 W/m-K at 38° C.

In a preferred embodiment of the invention, the first insulation material has a thermal conductivity k-factor value of less than 0.017 W/m-K at 38° C.

In a further preferred embodiment of the invention, the innermost insulation layer has a thermal conductivity (k-factor) equal to or less than 0.015 W/m-k at 38° C.

In an embodiment of the invention, the first insulation material comprises a microporous insulation material which is substantially inorganic based or a nanoporous insulation material which is substantially inorganic based.

In an embodiment of the invention, the microporous insulation material or the nanoporous insulation material is silica based.

In an embodiment of the invention, the first insulation material comprises a substantially inorganic based aerogel. In a further embodiment of the invention, the aerogel is based on silica.

In an embodiment of the invention, the first insulation material is fumed silica

In an embodiment of the invention, the first insulation layer further comprises one or more of: a binder, reinforcing fibers, a reinforcing woven fabric, and a reinforcing unwoven fabric.

In an embodiment of the invention, the composite insulation system comprises a second insulation layer comprising a second insulation material.

In an embodiment of the invention, the second insulation material is a polymeric foam.

In an embodiment of the invention, the polymeric foam is polyurethane foam, polyisocyanate foam or phenolic foam.

In an embodiment of the invention, the second insulation material is syntactic polymeric foam.

In an embodiment of the invention, the second insulation material is a syntactic foam based on polyurethane, epoxy, polyisocyanurate, phenolic resole, or a thermoplastic, such as polypropylene or polystyrene.

In an embodiment of the invention, the polymeric foam is thermoplastic foam.

In an embodiment of the invention, the thermoplastic polymeric foam comprises polyethylene, polypropylene, or polystyrene.

In an embodiment of the invention, the first insulation material is selected from a group consisting of: fumed silica, microporous silica, nanoporous silica, and a silica based aerogel and the second insulation material is a polymeric foam comprising polyurethane or polyisocyanurate.

In an embodiment of the invention, the insulated pipe further comprises a first bonding layer for securing said composite insulation system to said pipe, wherein said bonding layer is disposed between first insulation layer and the pipe.

In an embodiment of the invention, the first bonding layer comprises an adhesive, an anti-corrosion agent, a primer or combinations thereof.

In an embodiment of the invention, the adhesive is selected from a group consisting of: an epoxy based adhesive, a silicone based adhesive, a polyurethane based adhesive, a modified rubber based adhesive, a hydraulic cement based adhesive, and a ceramic based adhesive.

In an embodiment of the invention, the insulated pipe further comprises a first reinforcement layer disposed between said first insulation layer and said second insulation layer.

In an embodiment of the invention, the first reinforcement layer comprises a woven fabric, an unwoven fabric or a scrim.

In an embodiment of the invention, the woven fabric or the unwoven fabric comprises a material selected from a group consisting of: carbon fiber, glass fiber, steel, ceramic, high temperature resistant polymers and polyester.

In an embodiment of the invention, the insulated pipe further comprises a second reinforcement layer disposed over the second insulation layer.

In an embodiment of the invention, the second reinforcement layer comprises a polymeric based tape.

In an embodiment of the invention, the insulated pipe further comprises an outer jacket disposed over the second insulation layer or the second reinforcement layer.

In an embodiment of the invention, the outer jacket is resistant to water ingress.

In an embodiment of the invention, the outer jacket is resistant to soil stress forces.

In an embodiment of the invention, the outer jacket comprises a material selected from a group consisting of: a thermoplastic polymeric jacket, an elastomeric coating, a metallic jacket or a reinforced thermoset polymeric jacket.

In a further embodiment of the invention, the outer jacket may comprise a steel or aluminum jacket. In a further embodiment of the invention, the outer jacket may comprise an extruded polyethylene jacket or an extruded polypropylene jacket.

In an embodiment of the invention, the insulated pipe further comprises a second bonding layer disposed between said second insulation layer and said outer jacket.

In an embodiment of the invention, the insulated pipe further comprises a second bonding layer disposed between said second reinforcement layer and said outer jacket

In an embodiment of the invention, the second bonding layer comprises an adhesive.

In an embodiment of the invention, the adhesive is selected from a group consisting of: an epoxy based adhesive, a silicone based adhesive, a polyurethane based adhesive, a modified rubber based adhesive, a hydraulic cement based adhesive, and a ceramic based adhesive.

### BRIEF DESCRIPTION OF THE DRAWINGS

Preferred embodiments of the invention will now be described, by way of example, with reference to the accompanying drawings, in which:

FIG. 1 shows how the thermal barrier properties of the first (innermost) layer of insulation will influence the total insulation thickness when the interface temperature between the first and second insulation layers is limited by the temperature resistance of the second layer.

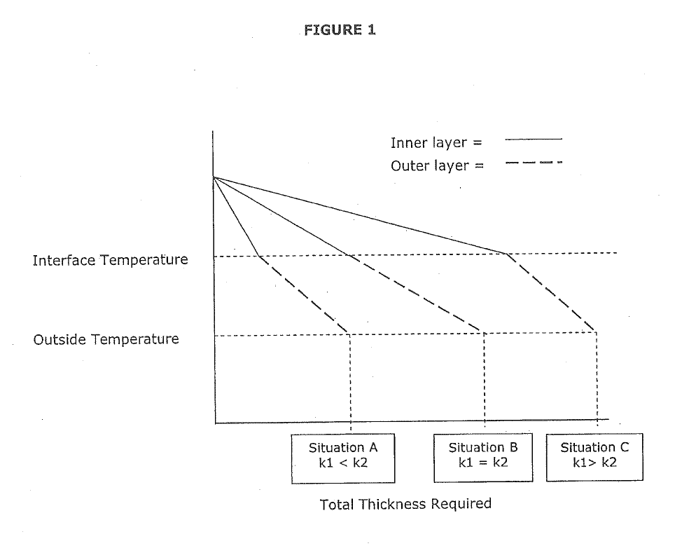

FIG. 2 is a partial, cross-sectional view of an insulated pipe comprising a pipe, a bonding layer, a first insulation layer, a second insulation layer and an outer jacket; and

FIG. 3 is a partial, cut-away view of an insulated pipe comprising a pipe, a first bonding layer, a first insulation layer, a first reinforcement layer, a second insulation layer, a second reinforcement layer, a second bonding layer and an outer jacket; and

Similar references are used in different figures to denote similar components.

### DETAILED DESCRIPTION

The present invention provides a thermally insulated pipe comprising a pipe and a composite insulation system, particularly suited for use at very high operating temperatures (i.e. greater 150° C.). The composite insulation system is formed in situ by application of the first insulation layer to the exterior surface of the pipe followed by application of an additional insulation layer to surround said first insulation layer. Application of at least one of the insulation layers is performed in a continuous manner.

As used herein the term “continuous manner” in the context of the application of insulation materials or layers thereof, refers to any suitable method of application capable of applying the insulation materials or layers thereof onto a length of pipe which moves in relation to a station applying or delivering said insulation layer. The particular method of continuous application will depend on the choice of insulation materials. For example, wherein the insulation material comprises a foam or a liquid coating, the insulation layer can be formed in situ by continuous spray onto the pipe to be insulated. Where the insulation material is in the form of a sheet or tape, the insulation layer is formed in situ by continuous wrapping of the sheet or tape to the pipe to be insulated.

The insulated pipe according to the invention may be used in a variety of applications including subsea and subterranean pipelines. The choice of insulation materials and the inclusion of additional elements such bonding layers, reinforcement layers and outer jackets for the manufacture of insulated pipes according to the invention will depend on the intended application.

In preferred embodiments, the present invention may comprise a pre-manufactured high efficiency insulation material as a thermal barrier layer underneath either spray applied or molded PUF/PIR foam insulation. By using a pre-manufactured thermal barrier layer, it is possible to eliminate or reduce the requirements for baking or curing processes associated with traditional cast-in-place mineral based insulations. Furthermore, the high insulation value of the materials of the present greatly minimizes the temperature transmitted to the polymeric foam layer and also reduces the total volume amount of PUF/PIR insulation that is required to be applied over top.

Additionally, in circumstances where it is desirable to use the high efficiency insulation materials as a wrap applied product, it may be possible to manufacture a high temperature composite insulation in an existing coating plant with reduced additional capital expenditures, and increased production efficiency compared to traditional mineral-based heat resistant materials.

The composite insulation system comprises multiple layers of insulation and is useful for thermally insulating pipes and other tubulars which are used to transport petroleum products, natural gas, steam, hot water and other chemical substances. The composite insulation system for pipes and other tubulars may comprise an inner more thermally stable material produced from inorganic or inorganic/organic combinations and which is over coated with an outer less thermally stable insulation layer generally produced from organic or organic/inorganic materials.

The composite insulation system utilizes a first, innermost layer of a more thermally stable insulation material applied to the outer surface of the pipe or other structure to be insulated. The first more thermally stable insulation layer minimizes the temperature transferred to the second layer of less thermally stable insulation, thus allowing materials unsuitable for direct exposure to the process temperature to be selected for the second layer.

As used herein, the term “insulate” means to isolate an object from its surroundings with a material of low thermal conductivity in order to reduce the transfer of heat energy between the object and its surroundings.

As used herein, the term “insulation” refers to those materials or combination of materials that retard the flow of heat in comparison with an absence of said material(s) interposed between an object and its surroundings.

As used herein, the term “foam” refers to materials that contain discrete bubbles of gas.

As used herein, the term “blown foam” refers to foam in which the bubbles are surrounded by the polymer from which the foam is composed. Such foams may be created by the generation of gas bubbles through chemical reaction or by introducing gas into a liquid polymer and solidifying it before the bubbles can coalesce.

As used herein, the term “syntactic foam” refers to foam in which the bubbles are incorporated in the form of hollow microspheres in which the shell is a ceramic such as glass, or alternately polymeric.

As used herein, the term “fibrous insulation” describes an insulation composed primarily of small diameter fibers that finely divide the air space. Typical fibrous insulations include silica, rock wool, slag wool or alumina silica.

As used herein, the term “granular insulation” describes an insulation composed of small nodules that contain voids or hollow spaces and/or which fit together very poorly, thereby creating very small voids between the particles even when compressed. Common granular insulations include calcium silicate, diatomaceous earth, expanded vermiculite, perlite, cellulose or microporous insulations.

As used herein, the term “loose-fill insulation” includes insulation in granular, nodular, fibrous, powdery or similar form designed to be installed by pouring, blowing or hand placement in such a way as to minimize compaction.

As used herein, the terms “loose insulation” or “fill insulation” includes insulation consisting of loose granules, fibers, beads, flakes, etc., which must be contained and are usually placed in cavities with minimal compaction.

As used herein, the terms “microporous insulation” and “nanoporous insulation” includes insulation materials comprising compacted powder or fibers with an average interconnecting pore size comparable to or below the mean free path of air molecules at standard atmospheric pressure. Microporous and nanoporous insulation may contain opacifiers to reduce the amount of radiant heat transmitted. Nanoporous insulation describes insulation materials having pores which are generally less than 100 nm in size.

As used herein, the term “sprayed-on insulation” includes insulation of the fibrous or foam type that is applied to a surface by means of power spray devices.

As used herein, the term “mineral fiber” includes insulation materials composed principally of fibers manufactured from rock, slag, or glass, with or without binders.

As used herein, the terms “mineral wool” and “rock wool” include synthetic vitreous fiber insulation materials made by melting predominantly igneous rock, and or furnace slag, and other inorganic materials, and then physically forming the melt into fibers. Other materials may be applied to the mineral wool such as binders, oils, etc.

As used herein, the term “aerogel” includes insulations that comprise materials prepared by the sol-gel method and in which the original dimensions of the gel are retained after all liquid has been replaced by gas. An aerogel typically contains greater than 98% by volume of gas, and has a three-dimensional structure whose dimensions are in the 10 to 1000 nm range.

As used herein, the term “perlite” includes insulation materials comprising natural perlite ore expanded to form a cellular structure.

As used herein, the term “calcium silicate” insulation includes materials comprising hydrous calcium silicate, and which usually contains reinforcing fibers.

As used herein, the term “fumed silica” includes insulation materials comprising silica produced by controlled vapour hydrolysis of silicon tetrachloride in a hydrogen oxygen flame.

As used herein, the term “thermal conductivity” refers to the ability of a material to conduct heat.

As used herein, the term “K-factor” is a measure of thermal conductivity expressed as the amount of heat that will flow per unit time through a given exposed surface area of the material for a given thickness and temperature difference. Thus, the units of k are watts per m² of exposed area per degree K. temperature difference per m thickness (W/m²/degree K/m), which is commonly reduced to W/m-K. When expressed in w/m-K, the term “lambda” is often used in place of, or interchangeably with, the term “K-factor”. In English units the most commonly used unit is BTU-inch/hour-ft²-° F. Thermal conductivity is temperature-dependent, typically increasing with increasing temperature. There are a number of methods for measuring k-factor, including ASTM C 177, ASTM C 335, ASTM C 518, ASTM C 1041 or ASTM C 1045. The differences are largely dependent on sample configuration, temperature gradient and the method for measuring heat flow.

As used herein, the term “thermal conductivity k-factor” means the thermal conductivity expressed as k-factor. Where multiple layers are involved, the term refers to the net thermal conductivity of the layers calculated as if they were one layer.

As used herein with respect to insulation materials, the term “maximum operating temperature limit” means the highest operating temperature which the insulation material can withstand without significant decomposition and/or loss of insulating capabilities over the expected service life of the pipe on which the insulation material is applied

As used herein, the term “jacket” refers to a covering placed over the outermost surface of the insulation for various functions. A jacket may be employed, among other reasons, to secure an insulation and/or to protect the insulation for moisture ingress and/or to protect the insulation from physical damage.

In an aspect of the invention, provided is an insulated pipe comprising a pipe and a composite insulation system, said composite insulation system comprising: (a) a first insulation layer comprising a first insulation material having a thermal conductivity k-factor value of less than 0.023 W/m-K at 38° C.; and (b) at least one additional insulation layer comprising an insulation material having a thermal conductivity k-factor greater than that of the first insulation material and a maximum operating temperature limit less than that of the first insulation layer. The composite insulation system is bonded to an exterior surface of the pipe with the first insulation layer facing towards the exterior surface of the pipe. At least one of said first insulation layer or said at least one additional layer extends continuously about said exterior surface of the pipe.

In an embodiment of the invention, the composite insulation system is formed by application of the first insulation layer to the exterior surface of the pipe followed by application of an additional insulation layer to surround the first insulation layer, and wherein application of one or more of the first insulation layer or additional insulation layers is performed in an continuous manner.

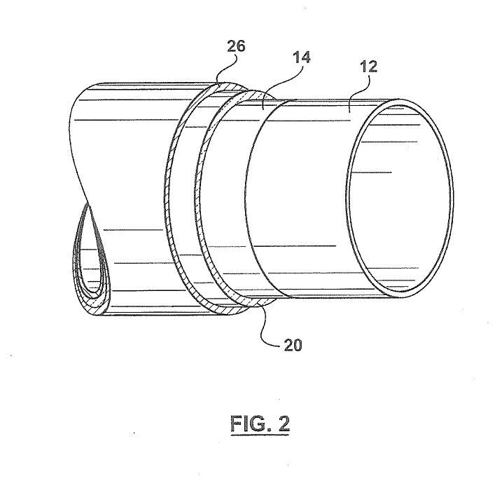

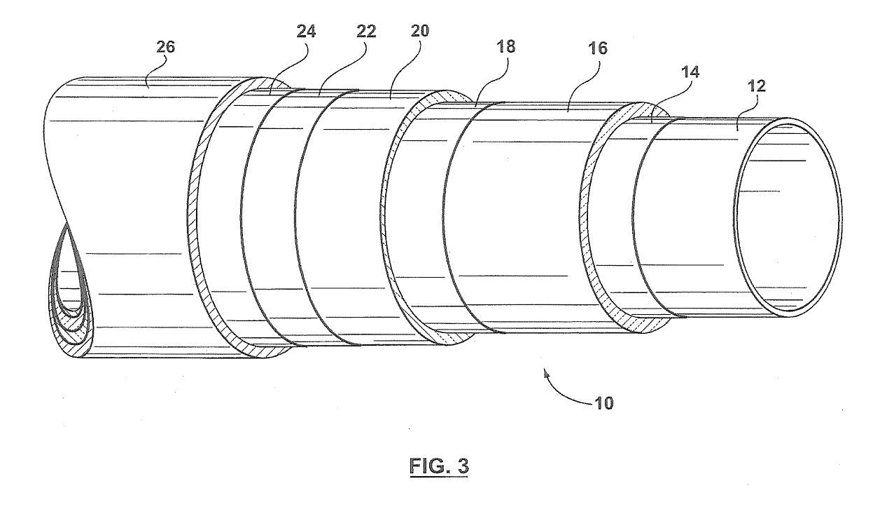

As shown in FIGS. 2 and 3, in an embodiment of the invention, the insulated pipe may further comprise a first bonding layer 14 applied to an exterior surface of the pipe 12 to be insulated for securing the composite insulation system to the pipe.

In another embodiment of the invention, the composite thermal insulation system may further comprise a first reinforcement layer 18 disposed over the first insulation layer 16.

In a further embodiment of the invention, the composite thermal insulation system may further comprise a second reinforcement layer 22 disposed over the second insulation layer 20.

In a further embodiment of the invention, the composite thermal insulation system may further comprise a second bonding layer 24 disposed over either over the second insulation layer 20 or the second reinforcement layer 22 if present.

In a further embodiment of the invention, the composite thermal insulation system may further comprise an outer jacket 26 disposed over the second insulation layer 20 or the second bonding layer 24 if present.

The insulated pipe according to the invention may be adapted for subsea applications. It is necessary that subsea pipelines have not only a good heat insulation but also protection against mechanical damage due to exposure to hydrostatic pressures and water penetration in order to prevent corrosion. Inclusion of an outer jacket which is resistant to water ingress and ambient pressures can be used to provide protection to the insulated pipe.

In another aspect, the present invention provides an insulated pipe for use in an undersea pipeline, comprising: a pipe; a composite insulation system and an outer jacket. The composite insulation system comprises: (a) a first insulation layer comprising a first insulation material having a thermal conductivity k-factor value of less than 0.023 W/m-K at 38° C. and (b) at least one additional insulation layer comprising an insulation material having a thermal conductivity k-factor greater than that of the first insulation material and a maximum operating temperature limit less than that of the first insulation layer. The composite insulation system is applied to an exterior surface of said pipe with the first insulation layer facing towards said exterior surface of said pipe. At least one of said first insulation layer or said at least one additional layer extends continuously about said exterior surface of the pipe. The outer jacket covers the composite insulation system, protecting the composite insulation system and pipe from water ingress and from ambient pressure.

In an embodiment of the invention, the composite insulation system is formed by application of the first insulation layer to the exterior surface of the pipe followed by application of an additional insulation layer to surround said first insulation layer wherein application of one or more of the first insulation layer or additional insulation layers is performed in a continuous manner.

The insulated pipe according to the invention may be adapted for subterranean applications. Buried pipelines are subject to deterioration due to mechanical and chemical damage. Long term exposure to soil stress forces may causes applied coatings and insulation layers to creep or detach from the pipe on which they are applied. The inclusion of at least one or more of a bonding layer (such as an adhesive layer) or a reinforcement layer (such as a tape layer) secures the composite insulation system to the pipe to be insulated and protects the resulting insulated pipe from soil stress forces (such as shear). The inclusion of an outer jacket which is resistant to water ingress protects both the insulation system and the pipe from deterioration and corrosion. The outer jacket may also be resistant to soil stress forces to provide further protection of the insulated pipe.

In a further aspect, the present invention provides an insulated pipe for use in a subterranean pipeline, comprising: a pipe; a composite insulation system, at least one of a bonding layer or reinforcement layer, and an outer jacket. The composite insulation system comprises: (a) a first insulation layer comprising a first insulation material having a thermal conductivity k-factor value of less than 0.023 W/m-K at 38° C.; and (b) at least one additional insulation layer comprising an insulation material having a thermal conductivity k-factor greater than that of the first insulation material and a maximum operating temperature limit less than that of the first insulation layer. The composite insulation system is applied to an exterior surface of the pipe with the first insulation layer facing towards said exterior surface of the pipe. At least one of said first insulation layer or said at least one additional layer extends continuously about said exterior surface of the pipe. At least one of a bonding layer and/or reinforcement layer is provided for securing the composite insulation system to the pipe. The at least one bonding layer and/or reinforcement layer protects the composite insulation system from soil stress forces. The outer jacket covers the composite insulation system and protects the composite insulation system and pipe from water ingress.

In an embodiment of the invention, the composite insulation system is formed by application of the first insulation layer to the exterior surface of the pipe followed by application of an additional insulation layer to surround said first insulation layer wherein application of one or more of the first insulation layer or additional insulation layers is performed in a continuous manner.

Innermost First Insulation Layer

The composite insulation system comprises multiple layers of insulation. Each insulation layer will differ from one another in terms of the insulation material used to form the individual insulation layers. Each insulation layer itself may be comprised of multiple layers of the particular insulation material. For example, an insulation layer may consist of a laminate of insulation materials.

The composite insulation system comprises at least a first insulation layer comprising a first insulation material and a second insulation layer comprising a second insulation material. The composite insulation system is applied to the pipe to be insulated with the first insulation layer facing towards the exterior surface of the pipe to be insulated such that the first insulation layer constitute the innermost insulation layer of the composite insulation system.

As used herein, reference to “innermost insulation layer” and “first insulation layer” refers to the insulation layer of the composite insulation system which faces the closest to the exterior surface of the pipe to be insulated.

The innermost insulation layer may be situated in direct contact with the pipe to be insulated. In some embodiments, it may be desirable to coat the exterior surface of the pipe to be insulated with anti-corrosion coatings and or other protective coatings known in the art. In other embodiments, it may be desirable to coat the exterior surface with an adhesive layer to form a bonding layer for securing the composite insulation system to the pipe to be insulated. In these embodiments, the innermost insulation layer may be applied over the protective coating or bonding layer (see further discussion below).

The primary function of the innermost insulation layer is to restrict heat flow to the second insulation layer, thereby reducing the temperature to a level which the second insulation layer can withstand for the required service life. The innermost insulation layer therefore comprises materials selected from materials which are more heat-resistant than those used in the second insulation layer, and which have thermal conductivity equal to or lower than that of the second insulation layer.

The second insulation layer normally provides much of the overall resistance to heat flow for the insulated pipe because it is substantially thicker than the innermost layer and is itself an excellent insulator. Ideally it is also relatively inexpensive in relation to the material used to form the innermost layer, and is convenient to apply in significant thickness.

The high efficiency insulation materials used to prepare the innermost insulation layer will have a k-factor value of equal to or less than 0.023 W/m-K at 38° C. as determined in accordance with standard thermal conductivity test methodologies known in the art, such as ASTM C177, ASTM C 335, ASTM C 518, ASTM C1041 or ASTM C1045. Preferably, the high efficiency insulation materials have a k-factor of less than 0.02/m-K at 38° C., more preferably a k-factor of less than 0.017 W/m-K at 38° C., and even more preferably a k-factor of less than 0.015 W/m-K at 38° C. In any event, the first insulation material will have a k-factor substantially equal to or lower than the effective k-factor of the second insulation layer.

The innermost insulation layer may comprise substantially inorganic materials or inorganic/organic based materials and in particular, substantially inorganic based microporous insulation materials and substantially inorganic based nanoporous insulation materials. Preferably, the substantially inorganic microporous and nanoporous insulation materials are silica based. Examples of suitable inorganic insulation materials include, but are not limited to: fumed silica, microporous silica, inorganic aerogel, and nanoporous silica. These thermal insulation materials provide very good temperature reductions per unit of applied thickness compared to traditional materials, such as perlite and calcium silicate (see Table 1). The first insulation layer, depending on the choice of insulation material, may further comprise one or more of: a binder, reinforcing fibers, a reinforcing woven fabric or a reinforcing unwoven fabric to provide structural integrity.

In a preferred embodiment of the invention, the innermost insulation layer comprises a silica based aerogel having a k-factor of less than 0.017 W/m-K at 38° C., and more preferably a silica based aerogel having a k-factor of less than 0.015 W/m-K at 38° C. Two examples of commercially available aerogel blankets are listed in Table 1, below.

The first insulation material may be in the form of a flexible blanket or in tape, and may comprise multiple layers thereof.

TABLE ONE
Comparison of Thermal Conductivity for Various Materials

| | | | | Microporous | Rock | | Calcium | |
|---|---|---|---|---|---|---|---|---|
| Item | Aerogel-1 | Aerogel-2 | Aerogel-3 | silica | wool | Perlite | Silicate | PIF |
| Product | Spaceloft | Pyrogel | Nanogel | Microtherm | Roxul | Sproule | Thermo- | ShawCor |
| Name | 2200 | 6650 | Thermal | Super-G | 1200 | WR-1200 | 12 Gold | HT Foam |
| | | Blanket | Wrap | Tape | | | | |
| Bulk | 130 | 120 | 75 | 320 | 140 | 192 | 232 | 60 |
| Density | | | | | | | | |
| (kg/m³) | | | | | | | | |
| Thermal | 0.0135 | 0.0145 | 0.021 | 0.022 | 0.038 | 0.069 | 0.052 | 0.0253 |
| Conductivity | | | | | | | | |
| at 38° C. | | | | | | | | |
| (W/m-K) | | | | | | | | |
| K-Factor | Aspen | Aspen | Bredero | Bredero | Roxul | Calsilite | Calsilite | Bredero |
| Data | Aerogels | Aerogels | Shaw | Shaw | Inc. | Group | Group | Shaw |
| Source | Spaceloft | Pyrogel | | | Revised | IIG-200 | IIG-300 | |
| | 2200 | 6650 | | | Dec. 21/2004 | 2-05 | 2-05 | |
| | Rev 1.0 | Rev 1.0 | | | | | | |

Substantially organic based materials including, but not limited to: binders, fibers or reinforcing fabrics may also be present or incorporated into the material comprising the first insulation layer.

In preferred embodiments of the invention, the first insulation layer may comprise a mineral based insulation material such as but not limited to fumed silica, microporous silica, nanoporous silica, a silica based aerogel and the second insulation layer (see further discussion below) may comprise a polymeric foam insulation material comprising polyurethane or polyisocyanurate. In a further preferred embodiment of the invention, the first insulation layer comprises a silica based aerogel and the second insulation layer comprises a polymeric foam insulation material comprising polyurethane or polyisocyanurate. In such embodiments, the thermal conductivity of the first insulation layer will be equal to or lower than that of the second insulation layer, and as such, the total insulation thickness will be smaller than what would be obtained using the second insulation layer by itself, in order to achieve comparable or superior overall insulation performance. Depending on the particular choice of insulation materials, at least one of the first or second insulation layers is formed in situ in a continuous manner and in some embodiments, both the first and second insulation layers are formed in a continuous manner. For example, some embodiments may be formed by continuous wrapping of the first insulation layer (for example, an aerogel blanket) onto the pipe followed by continuous spraying of polymeric foam insulation over the first insulation layer.

Second Insulation Layer

The second insulation layer will be of a composition that it cannot by itself, withstand the operating temperature of the pipe to be insulated for the expected service life of the pipe. In addition, the thermal conductivity of the second layer, or the effective k-factor in the case of the second insulation layer comprising multiple layers, will be equal to or higher than that of the first insulation layer.

The second insulation layer may be bonded directly to the first insulation layer. In some embodiments, the first and second insulation layers may be separated by a first reinforcement layer.

The second insulation layer may comprise substantially organic based insulation materials or substantially inorganic based insulation materials. Suitable organic insulating materials may include, but are not limited to: polyurethane foams, polyisocyanurate foams, thermoplastic foams (for example, expanded polyethylene, or polypropylene, polystyrene, etc). The organic foam may be blown foam or syntactic foam.

In a preferred embodiment, the second insulation layer may comprise a polymeric foam and more preferably polyurethane foam, polyisocyanurate foam or phenolic foam.

In another preferred embodiment, the second insulation layer may comprise a thermoplastic foam, and more preferably, a thermoplastic foam comprising polyethylene, polypropylene, or polystyrene binder.

In a further preferred embodiment, the second insulation layer may comprise a syntactic polymeric foam comprising polyurethane, polyisocyanurate, epoxy or phenolic binder. The syntactic polymeric foam may also comprise polypropylene or polystyrene binder.

In particularly preferred embodiments, materials for the second insulation layer are rigid closed cell polyurethane, polyisocyanurate, poly(urethane-isocyanurate), or phenolic foams. The higher the operating temperature capability of the second insulation layer, the thinner the innermost layer can be.

The second insulation layer may be applied onto first inner insulation layer or the reinforcement layer if employed, by a variety of processes known in the art such as: molding, pouring, injection, spraying, casting, etc, or as pre-formed pieces (i.e., “shells). The preferred method of application will depend on the particular choice of insulation material.

Securing or Bonding Layers

In some embodiments of the invention, means for securing the composite insulation system to the pipe may be provided. A first bonding layer may be provided for securing the composite insulation system to the pipe wherein the first bonding layer is disposed between the first insulation system and the exterior surface of the pipe. In such embodiments, the securing may take the form of adhesive bonding. In addition to containing an adhesive, the first bonding layer may comprise an anti-corrosion agent, a primer or combinations thereof depending on the intended application of the insulated pipe as discussed in further detail below.

In another embodiment, the composite insulation system may be secured to the pipe by applying a reinforcing layer, such as a fibrous material or adhesive tape which is wrapped around the outer circumference of the layer to be secured.

The purpose of securing the composite insulation system to the pipe is to prevent the innermost insulation layer from moving in relation to the pipe, and to prevent the various insulation layers from moving in relation to one another. Typical driving forces for such relative movement are differential thermal expansion of the components or expansion and contraction of the soil if the pipe is buried.

For certain applications, a bonding or adhesive layer may also serve as a corrosion resistant barrier to protect the pipe from the potentially corrosive effects of moisture vapor or water ingress or other agents into the coating system. This would be applied to the outer surface of the pipe prior to the installation of the innermost insulation layer, which would be applied while the bonding layer is still able to form a bond to it. Alternatively, the pipe might be provided with a fully functional anti-corrosion coating already applied, in which case the bonding or adhesive layer may be applied either to the coated pipe or the interior surface of the innermost insulation layer just prior to bringing the two into contact.

Materials suitable for use as the bonding layers include, but are not restricted to, epoxy based adhesives and coatings, silicone based adhesives and coatings, polyurethane based adhesives, cementitious or ceramic based mortars and adhesives, hydraulic cement based adhesives, heat-activated thermoplastic or thermoset adhesives or other common adhesive materials.

In further embodiments of the invention a second bonding or adhesive layer may be required to bond the second insulation layer to the outer jacket. The second bonding layer may comprise any of the adhesives referred to above

In embodiments of the invention, wherein the second insulation layer comprises expanded polymeric foam and an extruded polymeric outer jacket, the second bonding or adhesive layer is preferably an adhesive material based on asphalt modified rubber chemistry.

Reinforcement Layers

In some embodiments of the invention, a first reinforcement layer may be provided and disposed between the first insulation layer and the second insulation layer. In cases where it is desirable to reinforce or secure the first insulation layer to the pipe by physical means rather than adhesively, the first reinforcement layer must be capable of withstanding the temperature it will encounter in service. Materials suitable for such application comprise, but are not restricted to, organic or inorganic based materials, such as woven and unwoven fabrics of heat-resistant materials such as glass fiber, steel, ceramic, carbon fibers, polyester, and high temperature resistant polymers.

In embodiments wherein the first insulation layer comprises for example an aerogel blanket material, it may be desirable to apply a reinforcing mesh of non-woven materials, such as a scrim, to compress the aerogel blanket material, thereby improving the thermal insulation value of the aerogel blanket material by removing trapped air and reducing its physical thickness. The use of such a scrim also produces a smoother surface onto which the second insulation layer can be either spray applied or molded especially in the embodiments wherein the second insulation layer comprises PUF/PIR foam insulation. The scrim may be constructed of organic or inorganic (e.g. glass fiber) materials depending on the service temperature required, and is of an open mesh construction allowing the foam insulation to penetrate it and bond directly onto the underlying insulation material. This also allows the foam to encapsulate the scrim securing it in place. In some cases, the scrim material may not be required to be used if the insulation material of the first insulation layer is provided preformed, such as Microtherm Super G tape, or other equivalents known in the art.

The first reinforcement layer may be either pre-applied to the first insulation material prior to product assembly or may be separately applied once the first insulation layer is applied onto the pipe. The reinforcement layer may serve various purposes such as: (1) preventing damage to the inner layer during processing and product handling; (2) compressing or reinforcing the inner layer for retention or improvement of insulating value as well as to assist in maintaining the structural integrity of the system during manufacturing or in-service conditions; and (3) provides an additional anchor surface for the subsequently applied organic insulation, reducing the likelihood of loss of adhesion or delamination at the interface of the two materials during manufacturing or in-service conditions.

In some embodiments of the invention, it may be desirable to include a second reinforcement layer disposed over the second insulation layer to secure or reinforce the second insulation layer. The second reinforcement layer may comprise a tape layer or an equivalent wrap applied product. Polymeric based tapes are well known in the art. The use of a tape layer is particularly preferred in embodiments of the invention, wherein the second insulation layer comprises a polymeric insulating foam such as polyurethane or polyisocyanurate foam. The tape layer may be employed to reinforce the polymeric foam by providing additional mechanical protection or for securing an optional outer jacket to the second insulation layer. The use of a tape layer is particularly preferred in circumstances wherein the pipe to be thermally insulated is of large diameter or has heavy walls or in other circumstances where additional protection is required.

Outer Jacket

In some embodiments of the invention, it may be desirable to include an outer jacket. The outer jacket may serve to protect the insulation system from potential ingress of moisture, physical damage (i.e. resulting from exposure to soil stress) and also in some cases, the loss of the insulating blowing agents from certain polymeric foams used for the secondary insulation layer.

In a preferred embodiment, the outer jacket is resistant to water ingress and is particularly suited for use with pipes intended for subsea or subterranean application. In another embodiment, the outer jacket is may also be resistant to soil stress forces such as shear forces, and is particularly suited for subterranean application. Watertight polymeric coverings and watertight pipes (i.e. casings) are particularly suitable for use in subsea or subterranean environments.

The outer jacket may be comprised of polymeric materials including: polyethylene, polypropylene, nylon (such as nylon 11, nylon 12), polyurethane, polyurea or other suitable materials, of metallic materials such as steel, aluminum which may be optionally coated with an anticorrosion coating or, of composite materials such as fiber-reinforced resins or reinforced thermoset polymeric materials containing reinforcing materials such as glass fibers, mica, or other reinforcing materials. The jacket may also comprise unreinforced elastomeric coatings applied initially in liquid form and subsequently converted to solids by chemical reaction. Examples of such coatings include urethane elastomers, polyureas and epoxy coatings.

In a preferred embodiment, the outer jacket is an extruded polymeric jacket or covering comprising an extruded polyolefin, extruded polyimide, or an extruded elastomer. More preferably the outer jacket is an extruded high density polyethylene or an extruded polypropylene jacket. For polyethylene or polypropylene jackets, the materials can be applied onto the insulated pipe by either crosshead or side-wrap extrusion processes. In another preferred embodiment, the polymeric jacket or covering comprising a thermoset polymeric material such as but not limited to polyurethane or an epoxy. The polymeric jacket and covering is preferably watertight when used with insulated pipes intended for subseas or subterranean applications.

For certain molded foam based systems, the jacket may be in the form of a pre-manufactured plastic or metallic pipe (i.e. casing). In such embodiments, the innermost insulation layer is first attached to the pipe, and this assembly is inserted and centered in the casing. The second insulation layer is then applied by introducing the mixed components into the annular space and allowing the foam to rise and cure.

Although the invention has been described with reference to illustrative embodiments, it is to be understood that the invention is not limited to these precise embodiments, and that various changes and modification are to be intended to be encompassed in the appended claims.

1-60. (canceled)

61. An insulated pipe comprising a pipe and a composite insulation system, said composite insulation system comprising:
(a) a first insulation layer comprising a first insulation material having a thermal conductivity k-factor value of less than 0.023 W/m-K at 38° C.; wherein said first insulation material comprises a microporous or nanoporous silica which is substantially inorganic;
(b) at least one additional insulation layer comprising an insulation material having a thermal conductivity k-factor greater than that of the first insulation material and a maximum operating temperature limit less than that of the first insulation layer;
said composite insulation system bonded to an exterior surface of said pipe with the first insulation layer facing towards said exterior surface of said pipe; and
wherein at least one of said first insulation layer or said at least one additional layer extends continuously about said exterior surface of the pipe.

62. The insulated pipe according to claim 1, wherein the composite insulation system is formed by application of the first insulation layer to the exterior surface of the pipe followed by application of an additional insulation layer to surround said first insulation layer, and wherein application of one or more of the first insulation layer or additional insulation layers is performed in an continuous manner.

63. The insulated pipe according to claim 1, wherein the composite insulation system comprises a second insulation layer comprising a second insulation material.

64. The insulated pipe according to any one of claims 6 to 10, wherein the second insulation material comprises polymeric foam, a thermoplastic foam or a syntactic polymeric foam.

65. The insulated pipe according to claim 1, wherein the first insulation material is a silica based aerogel and the second insulation material is polymeric foam comprising polyurethane or polyisocyanurate.

66. The insulated pipe according to claim 5, wherein the silica based aerogel is in the form of a blanket and wherein the polymeric foam is spray or mould applied over said silica based aerogel blanket.

67. The insulated pipe according to claim 1, wherein the first insulation layer further comprises one or more of: a binder, reinforcing fibers, a reinforcing woven fabric, and a reinforcing unwoven fabric.

68. The insulated pipe according to claim 1, further comprising a first bonding layer for securing said composite insulation system to the pipe, wherein said bonding layer is disposed between the first insulation layer and the pipe.

69. The insulated pipe according to claim 8, wherein the first bonding layer comprises an adhesive, an anti-corrosion agent a primer or combinations thereof.

70. The insulated pipe according to claim 9, wherein the adhesive is selected from a group consisting of: an epoxy based adhesive, a silicone based adhesive, a polyurethane based adhesive, a modified rubber based adhesive, a hydraulic cement based adhesive, and a ceramic based adhesive.

71. The insulated pipe according to claim 3, further comprising a first reinforcement layer disposed between said first insulation layer and said second insulation layer, wherein the first reinforcement layer comprises a woven fabric, an unwoven fabric or a scrim.

72. The insulated pipe according to claim 10, wherein the woven fabric or the unwoven fabric comprises a material selected from a group consisting of: carbon fiber, glass fiber, steel, ceramic, high temperature resistant polymers and polyester.

73. The insulated pipe according to claim 3, further comprising a second reinforcement layer disposed over the second insulation layer.

74. The insulated pipe according to claim 12, wherein the second reinforcement layer comprises a polymeric based tape.

75. The insulated pipe according to claim 3, further comprising an outer jacket disposed over the second insulation layer or a second reinforcement layer optionally disposed over the second insulation layer, wherein said outer jacket is resistant to water ingress and/or soil stress forces.

76. The insulated pipe according to claim 15, wherein the outer jacket comprises: a polymeric jacket, an elastomeric coating, a metal jacket and a reinforced thermoset polymeric jacket.

77. The insulated pipe according to claim 15, further comprising a second bonding layer disposed between said second insulation layer and said outer jacket or a second bonding layer disposed between said second reinforcement layer and said outer jacket.

78. The insulated pipe according to claim 17, wherein the second bonding layer comprises an adhesive.

79. The insulated pipe according to claim 18, wherein the adhesive is selected from a group consisting of: an epoxy based adhesive, a silicone based adhesive, a polyurethane based adhesive, a modified rubber based adhesive, a cement based adhesive, and a ceramic based adhesive.
